(19) United States
(12) Patent Application Publication
(10) Pub. No.: US 2025/0091485 A1
(43) Pub. Date: Mar. 20, 2025

(54) EXIT ASSIST FUNCTION AND SEAT DEVICE INCLUDING THE SAME

(71) Applicant: HYUNDAI MOBIS CO., LTD., Seoul (KR)

(72) Inventors: Ji Soo SHIN, Yongin-si (KR); Tae Hun KIM, Suwon-si (KR); Sung Joon AHN, Seoul (KR)

(73) Assignee: HYUNDAI MOBIS CO., LTD., Seoul (KR)

(21) Appl. No.: 18/802,293

(22) Filed: Aug. 13, 2024

(30) Foreign Application Priority Data
Sep. 14, 2023 (KR) 10-2023-0122584

(51) Int. Cl. B60N 2/02; B60N 3/06

(52) U.S. Cl. CPC B60N 2/0273; B60N 3/063; B60N 2002/0204

(57) ABSTRACT

A seat device with an exit assist function includes a seat cushion; a seat base plate configured to support a lower end of the seat cushion; an actuator unit configured to move the seat cushion; a weight sensor configured to detect a weight of an occupant; an exit assist button configured to provide an exit assist operation signal; and a controller configured to control the actuator unit. Upon receiving the exit assist operation signal, the controller receives weight data of the occupant from the weight sensor, sets an exit assist operation based on the weight data of the occupant, sets a control value of the actuator unit based on the set exit assist operation, and controls the seat cushion to move based on the control value of the actuator unit.

This application claims the benefit of Korean Patent Application No. 10-2023-0122584, filed on Sep. 14, 2023, which is hereby incorporated by reference as if fully set forth herein.

### BACKGROUND OF THE INVENTION

### Field of the Invention

The embodiments of the present disclosure are applicable to vehicles of all fields, and more particularly to an exit assist function and a seat device including the same.

The present embodiments are applicable to vehicles in all fields, and more specifically, may be applied to, for example, an exit assist function and a seat device including the same.

### Discussion of the Related Art

The Society of Automotive Engineers (SAE), the American Society of Automotive Engineers, subdivides autonomous driving levels into six levels, for example, from level 0 to level 5.

Level 0 (No Automation) refers to a level at which a driver who rides in an autonomous vehicle controls and is responsible for all of vehicle driving. At Level 0, the driver can always drive the vehicle, and a system of the autonomous vehicle is designed to perform only auxiliary functions such as emergency situation notification. In addition, vehicle driving can be controlled by the driver, variables generable during vehicle driving can be sensed by the driver, and the driver is responsible for such vehicle driving.

Level 1 (Driver Assistance) refers to a level of assisting a vehicle driver through adaptive cruise control and lane keeping functions. In Level 1, an autonomous vehicle system is activated so that driver assistance can be implemented using vehicle speed control, vehicle-to-vehicle distance maintenance, and lane keeping. Whereas vehicle driving can be controlled by all of the system and the driver, variables generable during vehicle driving can be sensed by the driver, and the driver is also responsible for such vehicle driving.

Level 2 (Partial Automation) refers to a level at which steering and acceleration/deceleration of the autonomous vehicle can be controlled by all of the driver and the vehicle for a certain period of time under specific conditions. At Level 2, it is possible to perform assistance driving in which steering of a vehicle (i.e., a host vehicle) running on a gentle curved road and the operation of maintaining a predetermined distance between a host vehicle and a preceding vehicle can be performed. However, at Level 2, variables generable during vehicle driving can be sensed by the driver, and the driver is generally responsible for such vehicle driving. At this time, the driver must always monitor the driving situation, and in a situation that the system does not automatically recognize the driving situation, the driver must immediately intervene forcibly in vehicle driving.

At Level 3 (Partial Automation), the system takes charge of driving the vehicle in a section under certain conditions such as a highway, and the driver intervenes in driving the vehicle only in hazardous situations. At Level 3, variables generable during the vehicle driving can be sensed by the system, so that there is no need to perform the above monitoring in a different way from Level 2. However, if the driving situation exceeds the system requirements, the system requests the driver to immediately intervene in driving the vehicle.

Level 4 (High Automation) enables autonomous driving of the vehicle on most roads. In Level 4, vehicle driving can be controlled by the system, and the system is responsible for such vehicle driving. The driver need not intervene in driving the vehicle on most roads except for roads under restricted situations. However, at Level 4, in certain conditions such as bad weather, the system may request the driver to immediately intervene in driving the vehicle, so that a vehicle driving control device capable of being controlled by humans such as the driver is needed in Level 4.

Level 5 (Full Automation) refers to a level at which the driver need not intervene in driving the vehicle, and the vehicle can be autonomously driven only by an occupant (or a passenger), not the driver. At Level 5, if the occupant inputs a destination to the system, the system takes charge of autonomous driving under all conditions. At Level 5, control devices for vehicle steering and acceleration/deceleration of the vehicle are unnecessary for autonomous driving.

Conventional vehicle seats do not have a function to automatically raise the height of a seat cushion when people with mobility issues ride in the vehicle, so there is a problem that the height of the seat cushion must be manually set through a mechanical device.

### SUMMARY OF THE INVENTION

Accordingly, embodiments of the present disclosure are directed to an exit assist function and a seat device including the same that substantially obviate one or more problems due to limitations and disadvantages of the related art.

In order to solve the above-described problems, the embodiments of the present disclosure provide a seat device including an exit assist function in which a seat cushion is raised and rotated when the passenger gets up from the seat, thereby helping the passenger stand up.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a seat device with an exit assist function may include: a seat cushion; a seat base plate configured to support a lower end of the seat cushion; an actuator unit configured to move the seat cushion; a weight sensor configured to detect a weight of an occupant; an exit assist button configured to provide an exit assist operation signal; and a controller configured to control the actuator unit. Upon receiving the exit assist operation signal, the controller may receive weight data of the occupant from the weight sensor, may set an exit assist operation based on the weight data of the occupant, may set a control value of the actuator unit based on the set exit assist operation, and may control the seat cushion to move based on the control value of the actuator unit.

The controller may select at least one exit assist operation from among a seat rear-side lifting assist operation, a seat right-side reinforcement assist operation, and a seat left-side reinforcement assist operation based on the weight data of the occupant.

The actuator may include: a first front actuator disposed at a front left bottom of the seat cushion; a second front actuator disposed at a lower front bottom of the seat cushion; a first rear actuator disposed at a rear left bottom of the seat cushion; and a second rear actuator disposed at a rear right bottom of the seat cushion. The controller may determine actuator control values of the first front actuator, the second front actuator, the first rear actuator, and the second rear actuator in response to the selected exit assist operation.

When the seat right-side reinforcement assist operation is selected as the exit assist operation, the controller may set an actuator control value of a value greater than that of the second front actuator to the first front actuator, and may set an actuator control value of a value greater than that of the first rear actuator. When the seat left-side reinforcement assist operation is selected as the exit assist operation, the controller may set an actuator control value of a value greater than that of the first front actuator to the second front actuator, and may set an actuator control value of a value greater than that of the first rear actuator to the second rear actuator.

The seat device may further include: an auxiliary footrest configured to detect a position of a foot of the occupant; and a foot detection sensor configured to detect a position of the foot. Upon receiving the exit assist operation signal, the controller may receive foot detection information of the occupant from the foot detection sensor, and may control the auxiliary footrest to move when the occupant's feet are not detected.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is an overall block diagram of an autonomous driving control system to which an autonomous driving device according to any one of embodiments of the present disclosure is applicable.

FIG. 2 is a diagram illustrating an example in which an autonomous driving device according to any one of embodiments of the present disclosure is applied to an autonomous vehicle.

FIG. 3 is a diagram illustrating a seat device including an exit assist function according to an embodiment of the present disclosure.

FIGS. 4A to 5B are diagrams illustrating examples of an actuator operation according to an exit assist function according to an embodiment of the present disclosure.

FIGS. 6 to 7 are diagrams illustrating examples of an exit assist operation corresponding to a passenger according to one embodiment of the present disclosure.

FIG. 8 is a flowchart illustrating examples of an exit assist function according to one embodiment of the present disclosure.

### DESCRIPTION OF SPECIFIC EMBODIMENTS

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

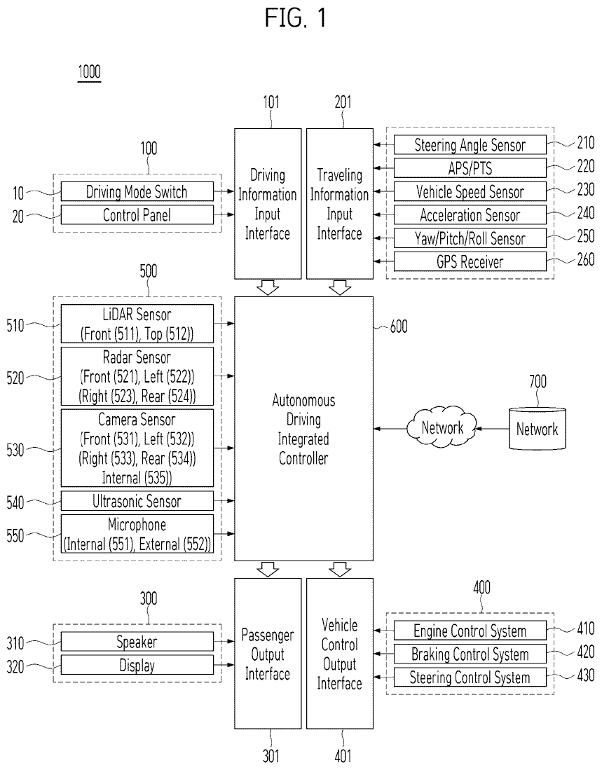

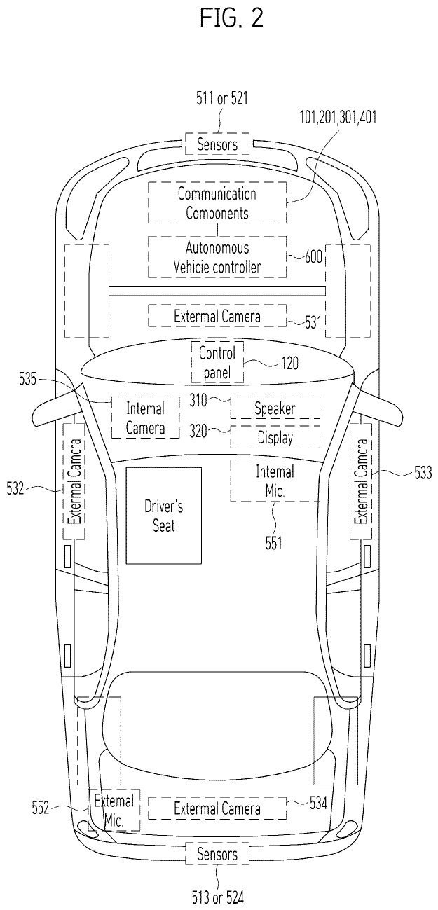

FIG. 1 is an overall block diagram of an autonomous driving control system to which an autonomous driving device according to any one of embodiments of the present disclosure is applicable. FIG. 2 is a diagram illustrating an example in which an autonomous driving device according to any one of embodiments of the present disclosure is applied to a vehicle.

First, a structure and function of an autonomous driving control system (e.g., an autonomous driving vehicle) to which an autonomous driving device according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller. The controller 600 according to an exemplary embodiment of the present disclosure may be a hardware device implemented by various electronic circuits (e.g., computer, microprocessor, CPU, ASIC, circuitry, logic circuits, etc.). The controller 600 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The controller 600 may embody one or more processor(s).

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving device according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

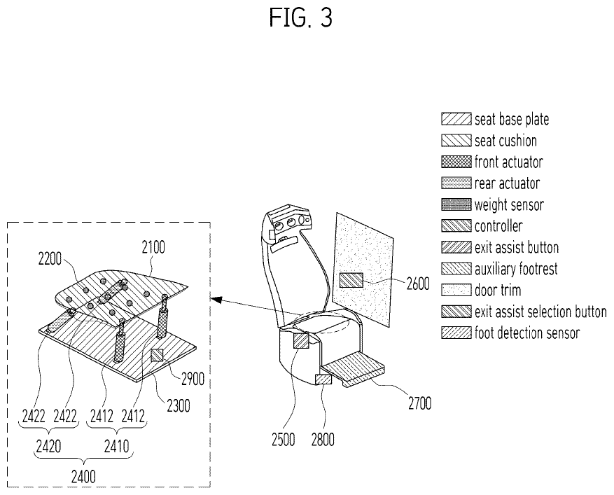

FIG. 3 is a diagram illustrating a seat device 2000 including an exit assist function according to an embodiment of the present disclosure.

Referring to FIG. 3, the seat device 2000 including the exit assist function may include a seat cushion 2100, a weight sensor 2200, a seat base plate 2300, an actuator unit 2400, an exit assist button 2500, an exit assist selection button 2600, an auxiliary footrest 2700, a foot detection sensor 2800, and a controller 2900.

The seat cushion 2100 may be a seat bottom cushion that touches the buttocks of a vehicle occupant when he or she sits on the seat.

The weight sensor 2200 may detect the weight of the occupant according to pressure applied by the occupant. The weight sensor 2200 may determine bias in the occupant's posture based on weight data, and may transmit information about a seating state of the occupant to the controller 2900.

The weight sensor 2200 may be placed inside the seat cushion 2100, without being limited thereto.

The seat base plate 2300 may be a plate that supports a lower end of the seat cushion 2100.

The actuator unit 2400 may include a front actuator 2410 that moves a front portion of the seat cushion 2100 and a rear actuator 2420 that moves a rear portion of the seat cushion 2100.

The front actuator 2410 may include a first front actuator 2411 disposed at a front left bottom of the seat cushion 2100 and a second front actuator 2412 disposed at a front right bottom of the seat cushion 2100.

The rear actuator 2420 may include a first rear actuator 2421 disposed at a rear left bottom of the seat cushion 2100 and a second rear actuator 2422 disposed at a rear right bottom of the seat cushion 2100.

The exit assist button 2500 may be placed on a side cover of the seat, and may be a button to activate the exit assist function.

The exit assist selection button 2600 may be placed on a door trim and may be a button for selecting an automatic or manual mode for the exit assist function of the driver's seat.

The auxiliary footrest 2700 may be a footrest for a child passenger to easily climb onto the seat when boarding. The auxiliary footrest 2700 may be a footrest that operates when the child passenger uses the exit assist function.

The foot detection sensor 2800 may be a sensor that recognizes whether the foot of the occupant or passenger seated on the seat has touched the floor.

The controller 2900 may control at least one of the actuator unit 2400 and the auxiliary footrest 2700.

The controller 2900 may be placed on the sheet base plate 2300, but the position of the controller 2900 is not limited thereto.

When the controller 2900 receives the exit assist operation signal, the controller 2900 may receive weight data of the occupant or passenger from the weight sensor 2200.

The controller 2900 may set an exit assist operation based on the weight data of the occupant.

The controller 2900 may select at least one of a seat's rear-side lifting assist operation, a seat's right-side reinforcement assist operation, and a seat's left-side reinforcement assist operation based on the occupant's weight data.

The controller 2900 may set a control value of the actuator unit 2400 based on the set exit assist operation.

The controller 2900 may set actuator control values for each of the first front actuator 2411, the second front actuator 2412, the first rear actuator 2421, and the second rear actuator 2422 in response to the selected exit assist operation.

When the seat right-side reinforcement assist operation is selected as the exit assist operation, the controller 2900 may set an actuator control value of a value greater than that of the second front actuator 2412 to the first front actuator 2411, and may set an actuator control value of a value greater than that of the second rear actuator 2422 to the first rear actuator 2422.

When the seat left-side reinforcement assist operation is selected as the exit assist operation, the controller 2900 may set an actuator control value of a value greater than that of the first front actuator 2411 to the second front actuator 2412, and may set an actuator control value of a value greater than that of the first rear actuator 2421 to the second rear actuator 2422.

The controller 2900 may control the seat cushion 2100 to move based on the setting value of the actuator unit 2400.

When receiving the exit assist operation signal, the controller 2900 may receive foot detection information of the occupant (or passenger) from the foot detection sensor 2800.

The controller 2900 may control the auxiliary footrest 2700 to move when the occupant's foot is not detected.

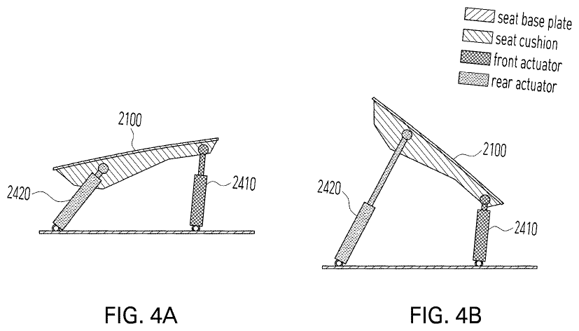

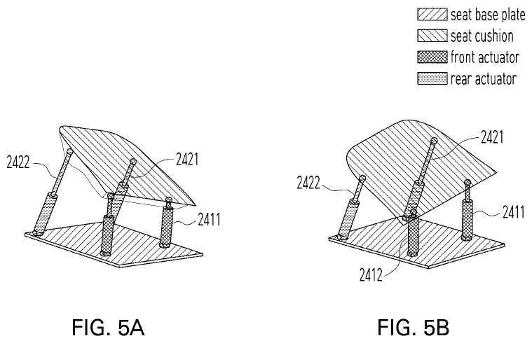

FIGS. 4A to 5B are diagrams illustrating examples of an actuator operation according to an exit assist function according to an embodiment of the present disclosure.

Referring to FIG. 4A, before the exit assist operation signal of the seat cushion 2100 is input, the front actuator may be raised by a preset value, and the rear actuator may be set to a minimum value, so that a slope from the front portion to the rear portion of the seat is formed.

Thereafter, referring to FIG. 4B, the rear portion of the seat may be moved in response to the exit assist operation signal of the seat cushion 2100. To this end, the rear actuator may operate so that the front portion of the seat can be raised.

Referring to FIG. 5A, the seat device 2000 including the exit assist function may perform the seat right-side reinforcement assist operation based on the exit assist operation signal. To this end, actuator control values may be input to the first front actuator 2411, the second front actuator 2412, the first rear actuator 2421, and the second rear actuator 2422, respectively.

That is, the first front actuator 2411 may receive an actuator control value of a value greater than that of the second front actuator 2412, and the first rear actuator 2421 may receive an actuator control value of a value greater than that of the second rear actuator 2422.

At this time, the smallest actuator control value may be provided to the second front actuator 2412, the largest actuator control value may be input to the first rear actuator 2421, and the second rear actuator 2422 may receive an actuator control value that is larger than a control value input to the first front actuator 2411 and smaller than the control value input to the first rear actuator 2421.

Accordingly, the seat right-side reinforcement assist operation can be performed in which the first front actuator 2411 raises the seat cushion 2100 higher than the second front actuator 2412 and the first rear actuator 2421 raises the seat cushion 2100 higher than the second rear actuator 2422 so that the height of a right hip of the occupant can be raised.

Referring to FIG. 5B, the seat device 2000 including the exit assist function may perform the seat left-side reinforcement assist operation based on the exit assist operation signal. To this end, actuator control values may be input to the first front actuator 2411, the second front actuator 2412, the first rear actuator 2421, and the second rear actuator 2422, respectively.

That is, an actuator control value received by the second front actuator 2412 may be larger than an actuator control value received by the first front actuator 2412, and an actuator control value received by the second rear actuator 2422 may be larger than an actuator control value received by the first rear actuator 2421.

At this time, the smallest actuator control value may be provided to the first front actuator 2411, the largest actuator control value may be input to the second rear actuator 2422, and the first rear actuator 2421 may receive an actuator control value that is larger than a control value input to the second front actuator 2412 and smaller than the control value input to the second rear actuator 2422.

Accordingly, the seat right-side reinforcement assist operation can be performed in which the second front actuator 2412 raises the seat cushion 2100 higher than the first front actuator 2411 and the second rear actuator 2422 raises the seat cushion 2100 higher than the first rear actuator 2421 so that the height of the right hip of the occupant can be raised.

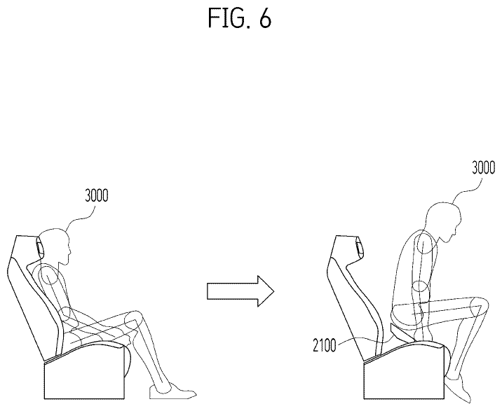

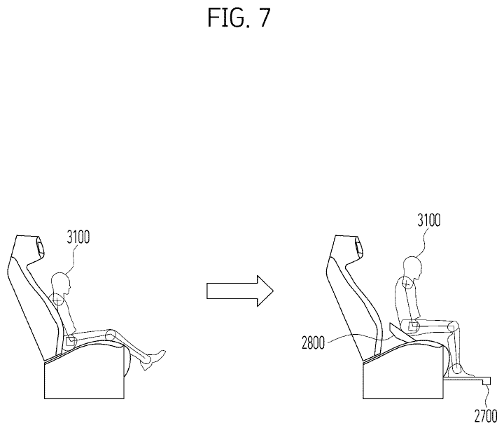

FIGS. 6 to 7 are diagrams illustrating examples of the exit assist operation corresponding to the occupant 3000 according to one embodiment of the present disclosure.

Referring to FIG. 6, when the occupant 3000 is sitting on the seat, the buttocks of the occupant 3000 may be located behind the seat cushion 2100.

Thereafter, when the exit assist operation is performed for the occupant 3000 to stand up from the seat, the rear of the seat cushion 2100 may rise and the buttocks of the occupant 3000 may also rise. At the same time, the occupant 3000 may stand up from the seat with less force as the body of the occupant 3000 moves away from the seat.

Referring to FIG. 7, when a child 3100 is sitting on the seat, the buttocks of the child 3100 may be located behind the seat cushion 2100, and the feet of the child 3110 may be spaced apart from the floor of the vehicle.

Referring to FIG. 7, when the child 3100 is seated on the seat, the hip of the child 3100 may be located behind the seat cushion 2100, and the foot of the child 3100 may be spaced apart from the bottom of the vehicle.

Thereafter, when the exit assist operation is performed to allow the child 3100 to stand up from the seat, the rear of the seat cushion 2100 may rise and the buttocks of the occupant 3000 may also rise. In addition, the foot detection sensor 2800 does not recognize the feet of the child 3100, the auxiliary footrest may move forward from the child 3100.

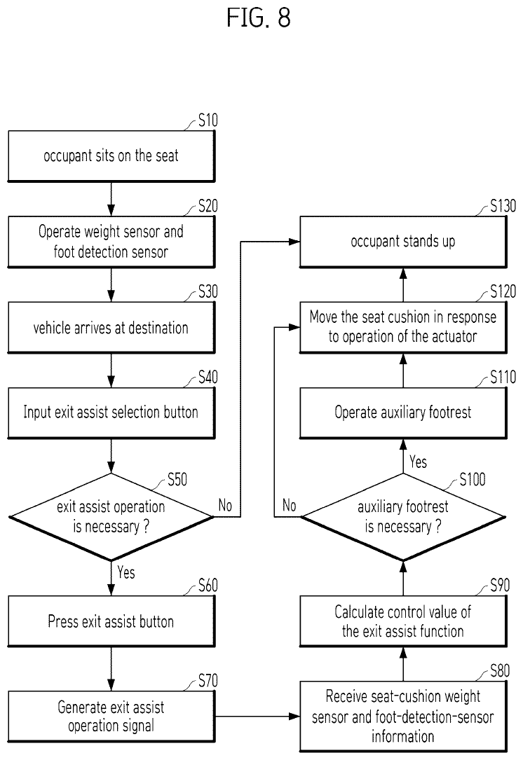

FIG. 8 is a flowchart illustrating examples of the exit assist function according to one embodiment of the present disclosure.

Referring to FIG. 8, the seat device 2000 including the exit assist function may operate the weight sensor 2200 and the foot detection sensor 2800 (S20) when the occupant sits on the seat (S10).

After step S20, the seat device 2000 including the exit assist function may receive an exit assist selection button signal placed on the driver's seat (S40) when the vehicle arrives at a destination (S30).

After step S40, the seat device 2000 including the exit assist function may determine whether the exit assist operation is necessary in response to the exit assist selection button signal (S50).

After step S50, the seat device 2000 including the exit assist function may generate the exit assist operation signal (S70) when the exit assist button is pressed in a situation where the exit assist operation is required (YES in S50).

After step S70, the seat device 2000 including the exit assist function may receive weight sensor information and foot detection sensor information, and may calculate a control value for performing the exit assist function (S80).

After step S90, the seat device 2000 including the exit assist function may determine whether operation of the auxiliary footrest is necessary (S100).

After step S100, the seat device 2000 including the exit assist function may move the auxiliary footrest forward (S110) when operation of the auxiliary footrest is required (YES in S100).

After the step S110, the seat device 2000 including the exit assist function may move the seat cushion 2100 by operating the actuator unit 2400 based on the calculated control value for performing the exit assist function (S120). Afterwards, the passenger can stand up from the seat (S130).

In other words, the technical idea of the present disclosure can be applied to the entire autonomous vehicle or only to some components inside the autonomous vehicle. The scope of the present disclosure should be determined according to the matters stated in the patent claims.

In another aspect of the present disclosure, the above-described proposal or operation of the present disclosure may be provided as codes that may be implemented, embodied or executed by a “computer” (System on Chip (SoC)), an application storing or containing the codes, a computer-readable storage medium, a computer program product, and the like, which also comes within the scope of the present disclosure.

A detailed description of preferred embodiments of the present disclosure disclosed as described above is provided so that those skilled in the art can implement and embody the present disclosure. Although the description is made with reference to the preferred embodiments of the present disclosure, it will be appreciated by those skilled in the art that various modifications and variations can be made in the present disclosure without departing from the spirit or scope of the disclosures. For example, those skilled in the art may use the respective components described in the above-described embodiments in a manner of combining them with each other.

Accordingly, the present disclosure is not intended to be limited to the embodiments shown herein, but to be given the broadest scope that matches the principles and novel features disclosed herein.

As is apparent from the above description, the embodiments of the present disclosure can provide the function of automatically raising the seat to some users who have difficulty standing among passengers seated on seats, thereby increasing convenience of the users who desire to exit the vehicle.

It will be apparent to those skilled in the art that various modifications and variations can be made in the present disclosure without departing from the spirit or scope of the inventions. Thus, it is intended that the present disclosure covers the modifications and variations of this invention provided they come within the scope of the appended claims and their equivalents.

What is claimed is:

1. A seat device with an exit assist function comprising:
a seat cushion;
a seat base plate configured to support a lower end of the seat cushion;
an actuator configured to move the seat cushion;
a weight sensor configured to detect a weight of an occupant;
an exit assist button configured to provide an exit assist operation signal; and
a controller configured to control the actuator unit,
wherein the controller is configured to:
upon receiving the exit assist operation signal, receive weight data of the occupant from the weight sensor,
set an exit assist operation based on the weight data of the occupant,
set a control value of the actuator based on the set exit assist operation, and
control the seat cushion to move based on the control value of the actuator.

2. The seat device according to claim 1, wherein the controller is configured to:
select at least one exit assist operation from among a seat rear-side lifting assist operation, a seat right-side reinforcement assist operation, and a seat left-side reinforcement assist operation based on the weight data of the occupant.

3. The seat device according to claim 2, wherein the actuator includes:
a first front actuator disposed at a front left bottom of the seat cushion;
a second front actuator disposed at a lower front bottom of the seat cushion;
a first rear actuator disposed at a rear left bottom of the seat cushion; and
a second rear actuator disposed at a rear right bottom of the seat cushion,
wherein
the controller is configured to determine actuator control values of the first front actuator, the second front actuator, the first rear actuator, and the second rear actuator in response to the selected exit assist operation.

4. The seat device according to claim 3, wherein the controller is configured to:
when the seat right-side reinforcement assist operation is selected as the exit assist operation, set an actuator control value of a value greater than that of the second front actuator to the first front actuator, and set an actuator control value of a value greater than that of the first rear actuator; and
when the seat left-side reinforcement assist operation is selected as the exit assist operation, set an actuator control value of a value greater than that of the first front actuator to the second front actuator, and set an actuator control value of a value greater than that of the first rear actuator to the second rear actuator.

5. The seat device according to claim 1, further comprising:
an auxiliary footrest configured to detect a position of a foot of the occupant; and
a foot detection sensor configured to detect a position of the foot,
wherein the controller is configured to:
upon receiving the exit assist operation signal, receive foot detection information of the occupant from the foot detection sensor, and control the auxiliary footrest to move when the occupant's feet are not detected.

6. An exit assist function comprising:
upon receiving an exit assist operation signal, receiving weight data of an occupant from a weight sensor,
setting an exit assist operation based on the weight data of the occupant;
setting a control value of an actuator based on the set exit assist operation; and
controlling a seat cushion to move based on the control value of the actuator.

7. The exit assist function according to claim 6, wherein the setting the exit assist operation based on the weight data of the occupant includes:
selecting at least one exit assist operation from among a seat rear-side lifting assist operation, a seat right-side reinforcement assist operation, and a seat left-side reinforcement assist operation based on the weight data of the occupant.

8. The exit assist function according to claim 7, wherein the setting the control value of the actuator based on the set exit assist operation includes:
setting actuator control values of a first front actuator, a second front actuator, a first rear actuator, and a second rear actuator in response to the selected exit assist operation,
wherein
the first front actuator is disposed at a front left bottom of the seat cushion,
the second front actuator is disposed at a front right bottom of the seat cushion,
the first rear actuator is disposed at a rear left bottom of the seat cushion, and
the second rear actuator is disposed at a rear right bottom of the seat cushion.

9. The exit assist function according to claim 8, wherein the setting the control value of the actuator based on the set exit assist operation includes:
when the seat right-side reinforcement assist operation is selected as the exit assist operation, setting an actuator control value of a value greater than that of the second front actuator to the first front actuator, and setting an actuator control value of a value greater than that of the first rear actuator; and
when the seat left-side reinforcement assist operation is selected as the exit assist operation, setting an actuator control value of a value greater than that of the first front actuator to the second front actuator, and setting an actuator control value of a value greater than that of the first rear actuator to the second rear actuator.

10. The exit assist function according to claim 6, further comprising:
upon receiving the exit assist operation signal, receiving foot detection information of the occupant from a foot detection sensor; and
when a foot of the occupant is not detected, controlling the auxiliary footrest to move.
